(19) United States
(12) Patent Application Publication
(10) Pub. No.: US 2011/0093171 A1
(43) Pub. Date: Apr. 21, 2011

(54) MACHINE LOSS-OF-CONTROL DETECTOR AND SHUTDOWN SYSTEM

(76) Inventor: Fabio Saposnik, Toronto (CA)

(21) Appl. No.: 12/954,790

(22) Filed: Nov. 26, 2010

Related U.S. Application Data
(63) Continuation-in-part of application No. 11/676,714, filed on Feb. 20, 2007, now Pat. No. 7,848,860.
(60) Provisional application No. 60/774,602, filed on Feb. 21, 2006.

(51) Int. Cl. G06F 19/00

(52) U.S. Cl. 701/50

(57) ABSTRACT

A method and system are described for machine loss of control detection. Intended motion (e.g. from a human operator or automatic control system) of the machine or a part of it is detected. Actual motion of the machine or a part of it is detected. Machine loss of control is determined in response to whether actual motion is materially different from operator intended motion. Actual motion is determined from angular motion signals from a gyroscopic angular sensor and, optionally, linear motion signals (e.g. acceleration via one or more accelerometers). Machine loss of control determination may be used to stop the actual motion (e.g. stopping power or fuel an engine, bypassing hydraulic fluid flow, etc). The method and system are adaptable to machines having one or more driving and actuating systems capable of malfunctioning in such a way as to cause the machine to move uncontrollably.

### CROSS-REFERENCE TO PRIOR APPLICATIONS

The present application is a continuation-in-part of application Ser. No. 11/676,714 filed Feb. 20, 2007, which claims the benefit of U.S. Provisional Application No. 60/774,602 filed Feb. 21, 2006, both of which documents are incorporated herein by reference in their entireties.

### COPYRIGHT

A portion of this specification contains material that is subject to copyright protection. The copyright owner has no objection to the facsimile reproduction by anyone of the patent document, as it appears in the Patent and Trademark Office patent file or records, but otherwise reserves all copyrights whatsoever.

### FIELD

The present application relates to machine loss-of-control detection and shutdown for machines having one or more driving and actuating means capable of malfunctioning in such a way as to cause the machine to move uncontrollably.

### BACKGROUND

Some machines, such as asphalt pavers and log loaders, comprise one or more driving and actuating systems where the operation, particularly speed and direction (e.g., forward and reverse, left and right, in and out, up and down), of each driving and actuating system is separately controlled. Each driving or actuating system often comprises a hydraulic pump for driving—either directly or through a valve—a motor, cylinder or actuator that is coupled to a crawler, wheel(s), linkage(s) or rotating platform. In other cases the driving and actuating systems include an electric motor, the application of electric power to which is controlled by means of switches.

Such machines thus have speed controllers; in some cases, there is a separate speed controller—e.g. a joystick—for different functions of the machine; in other cases, one controller determines the forward speed of the machine, and another determines the deviation from straight-ahead, i.e. the desired angular speed or rate of yaw. The latter may be, for example, a steering wheel or a knob. In yet other cases machines, such as knuckle-boom log loaders, use resolved motion control whereby one controller determines the horizontal speed of an end effector, such as a grapple or bucket, and another determines its vertical speed. The speed commands for each driving and actuating system of the machine are derived from these controllers.

When a hydraulic component malfunctions, e.g. because a swash-plate or spool gets stuck in the open position, or because a switch is welded shut by arcing, it is possible for the hydraulic or electric component to keep applying power to an actuator, crawler or wheel, even when electric power to the control element of said component is turned off.

A failure may be caused by other factors, other than hydraulic component failures. It could be caused by an electrical component failure as well, for example: a failure of the electronics inside a valve; a failure in a main electronic machine controller itself; a wire breaking. The failure may also be caused by a software-related problem: in a module that can be used in different machines, operation may be set e.g. to operate a Type 1 machine when in fact it is installed in a machine Type 2; or a module driving the valves may not be zeroed or calibrated properly. The failure may be caused by electric or electromagnetic interference, rather than a component failure—caused either by other loads within the machine being energized, or by external radio transmitters, etc.

Devices exist, for example in cars, which detect a machine skidding or rotating uncontrollably, and then modulate power to a wheel or wheels to counteract the problem. They are known, for example, by names such as anti-lock brakes (ABS), electronic-stability programs (ESP) and traction-control systems. These devices deal with problems of machine inertia and/or lack of friction between the machine tires and the ground. They rely on the machine systems being functional, so that the system controller may use the brakes, for example, to alleviate or solve the problem. Thus they do not address the problem of a component failure.

Other devices exist that detect a motion that is forbidden and react to it, such as heater-fans that are shut down when the unit tips over. Thus they do not distinguish between motion that is permissible in one context but not another.

Yet other devices detect a problem in a machine, such as the engine oil pressure being too low, and then shut the engine down. These react to the internal behaviour of the machine, rather than to the machine's behavior in its environment.

It is thus desired to have a machine loss-of-control detection and shutdown system that addresses one or more of these shortcomings. A solution that is reliable, easy to implement, and relatively inexpensive is highly desired.

### SUMMARY

A method and system are described for machine loss of control detection. Intended motion (e.g. from a human operator or automatic control system) of the machine or a part of it is detected. Actual motion of the machine or a part of it is detected. Machine loss of control is determined in response to whether actual motion is materially different from operator intended motion. Actual motion is determined from angular motion signals from a gyroscopic angular sensor and, optionally, linear motion signals (e.g. acceleration via one or more accelerometers). Machine loss of control determination may be used to stop the actual motion (e.g. stopping power or fuel an engine, bypassing hydraulic fluid flow, etc). The method and system are adaptable to machines having one or more driving and actuating systems capable of malfunctioning in such a way as to cause the machine to move uncontrollably.

The method and system seek to address a problem associated with uncontrollable machine motion caused by an internal failure in the machine, as opposed to problems of inertia or lack of traction, where the motion is of a type and range that would be normal—except that the operator (whether human or automatic) does not intend it. Also, the method and system primarily relate the actual movement of the machine to that which was expected, not to measurements internal to the machine.

### BRIEF DESCRIPTION OF THE DRAWINGS

In order that the subject matter may be readily understood, embodiments are illustrated by way of examples in the accompanying drawings, in which:

FIG. 1 is a block diagram of pertinent components for driving one side or function of a machine in accordance with one embodiment of the invention;

FIG. 2 is a block diagram of a controller in accordance with the embodiment of the invention of FIG. 1;

FIG. 3 is a block diagram of pertinent components for driving one side or function of a machine in accordance with one embodiment of the invention; and

FIG. 4 is a block diagram of a controller in accordance with the embodiment of the invention of FIG. 3.

### DETAILED DESCRIPTION

The basic elements in the system involve: detecting actual motion (directly or indirectly), detecting intended motion and determining machine loss-of-control when actual motion and intended motion are materially different. Negligible differences may be ignored. One or more thresholds may be developed to indicate the material differences. Action may be taken to stop machine motion in response to the loss-of-control detection in accordance with the configuration or other parameters of the machine as described further herein below. Action may be taken in different ways to stop or control the unintended motion as further described.

It is noted that “operator” herein need not reference a human operator providing intended motion control via an input device. Rather, “operator” may include a computer controlled device or system, such as a 2D or 3D control system, providing intended motion control. 2D or 3D control systems for paving systems are commercially available (e.g. PaveSmart™ 3D (LMGS-S) from Leica Geosystems AG and Trimble PCS900™ from Trimble Navigation Limited). These systems may utilize a digitized 2D or 3D map, e.g. of the highway that needs to be built, and employ GPS and/or land-based reference points (such as Trimble SPS930 Universal Total Station™), to parse that map and position information into speed commands for controlling operation of the machine. These are the commands that indicate what motion is desired, as opposed to a manually-operated device such as a joystick. In accordance with embodiments described herein, signals (digital or otherwise) representative of the commands or representative of the inputs provided from a manually-operated device may be used.

### Detection of Machine Motion

Machine motion may be detected by sensors such as gyroscope(s) to detect angular motion, such as yaw and accelerometer(s) to detect acceleration such as a machine speeding up, or it not slowing down when the commands to its motors, valves or pumps would indicate otherwise. In machines that are propelled by two crawlers, for example, two accelerometers may be used to detect when each side of the machine is behaving unexpectedly—e.g. because one crawler is (or both are) out of control. An accelerometer is a device that outputs a voltage that is proportional to its own acceleration. Examples of suitable accelerometers for the purposes herein are Micro Electro-Mechanical Systems (MEMS), piezoelectric, shear mode, capacitive spring mass based and Surface Acoustic Wave (SAW) accelerometers.

A gyroscope or a pair of accelerometers may be mounted in a location removed from the traction means of the machine or vehicle, and as such are easier to retrofit and more reliable than, and preferable to, other sensor types such as Hall-effect sensors, magnetic pick-up sensors, potentiometers and resolvers. The latter are located such that they are physically coupled to the traction or propulsion means, and are exposed to the weather and road hazards, such as rocks and salt spray; this also necessitates wires to be routed to such exposed locations, which makes them vulnerable to damage and the installation more laborious, potentially requiring disassembling or modifying part of the machine or the propulsion means. Alternatively, the latter sensors and wires may be protected from these hazards by heavy-duty enclosures or coupling means, which increases the cost of the installation. A gyroscope or a pair of accelerometers can be located in a protected part of the machine or vehicle, which makes the installation more reliable, easier to implement, and less costly.

### Determination of Expected Motion

Operator intended motion might be determined by reading operator controlled control inputs, such as joysticks that control speed: this may involve reading the actual magnitude of a command or simply detecting a null-command, e.g. when joysticks are positioned in a neutral or centered location. Control output signals to actuators may also be read as an indication of operator intent, reading a control voltage or current being supplied to the solenoid of a valve, pump or motor. As well, other operator controls indicating operator intended motion may be detected such as a stop command from the operator: this may include a master-disable switch that the operator controls.

An operator might be controlling the machine directly, for example via an operator control system located in it, or indirectly by remote control system; the control system might control directly the function of the machine or control a desired end result, such as machine trajectory, via a controller that resolves the desired end result into individual speed commands for each function of the machine.

Intended motion may be derived from commands (signals) from a 2D or 3D control system read/received from a data bus. The commands may be analyzed and respective speed and/or direction or other motion commands determined to indicate operator intended motion. For example, the commands may be defined by the system in accordance with a protocol established by the 2D or 3D control system provider or a group of providers and users, etc., defining a common standard for interoperability. In an alternative, rather than examining the commands, outputs to actuate particular valves, controllers, etc. generated in response to these commands may be evaluated to determine intended motion.

### Comparison of Actual Motion to Operator Intended Motion

The comparison between what the motion is, and what it is expected to be (i.e. intended by an operator), can be done by a control module that detects machine motion and determines what the expected motion is. If there is a discrepancy larger than a pre-determined threshold, this controller can act to stop the actual motion, disabling the machine or rendering ineffective the faulty actuator. Step(s) to disable or shutdown may be delayed and taken only when to the loss-of-control persists for a predefined length of time.

### An Implementation

In this sample implementation the system might be concerned with reacting to the malfunction of one or two pumps that control the linear translation and rate of yaw of a machine. This might be the case, for example, of an asphalt paver that is propelled and steered by two crawlers, one on each side of the machine. In this example, a human operator may provide motion controls via a joystick or other input.

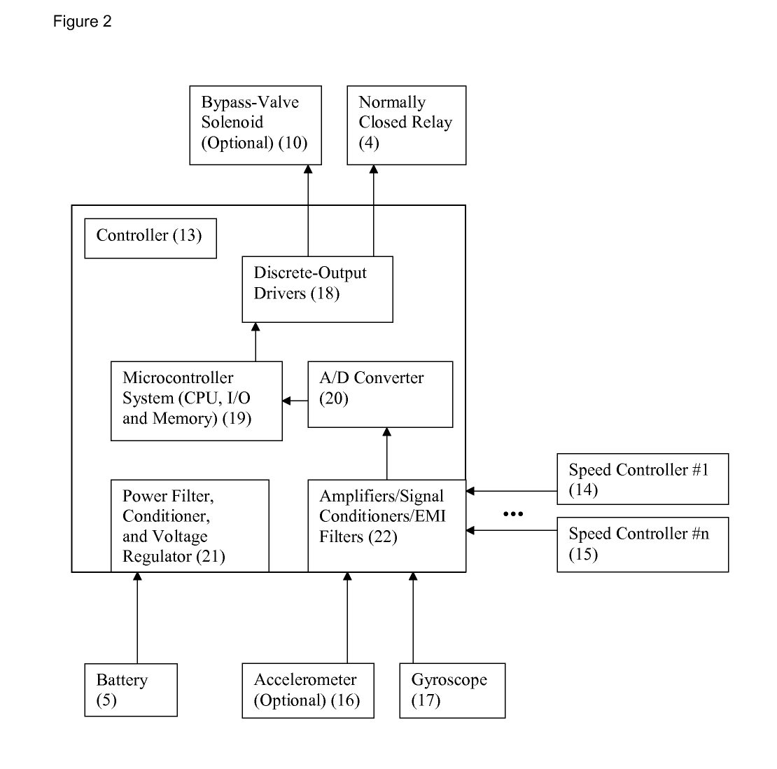

The controller may comprise of a micro-controller based system, an ND converter, signal conditioners, and power drivers such as depicted in FIG. 2.

The sensor used to detect machine motion is preferably a solid-state gyroscope. The controller also reads operator commands generated by the joysticks that control the machine.

The microcontroller reads the rate of yaw of the machine using the gyroscope. If an angular velocity with a magnitude greater than a preset threshold, e.g. ±3°/sec is detected when the operator command signal is about zero, and this condition persists for longer than a preset length of time, e.g. 1 sec, then the microcontroller causes the engine to shut down, such as by removing power from its fuel solenoid.

This implementation detects when the machine is rotating when it should not be. It would be possible for the machine to move uncontrollably without rotating, e.g. if two pumps failed on it; such a scenario would not be detected by a gyroscope. To deal with this, an accelerometer may be added, that the controller would use to detect machine translation.

A special case of this situation would involve the machine already moving at maximum speed, and then the speed controllers being centered: If the machine failed to decelerate, the controller would react to a lack of deceleration as it would to unwarranted acceleration—be it linear or angular, i.e. it would act to stop machine motion.

In general, variations on this scenario, whereby the control module acts to disable the machine, may include:
In a machine including a hydraulic pump that drives—directly or through a valve—a hydraulic motor to propel a crawler, and/or a cylinder or actuator:
   The microcontroller energizes a valve that bypasses the hydraulic pump flow, starving the motor, cylinder, or actuator. In this way, even if the pump, valve, motor or actuator are stuck open, the crawler, linkage or platform driven by it will stop. This could be implemented externally to the pump, by a valve diverting flow from the pump outlet to its inlet or to the hydraulic tank, or by a valve allowing flow from one port of the pump to another—e.g. from port A to port B.
   The microcontroller stops the engine, e.g. by energizing a solenoid that bypasses fuel flow to it, by energizing a relay that disconnects electric power to the spark plugs (if it is not a Diesel engine), and/or by de-energizing a fuel solenoid that feeds fuel to the engine.
In a machine powered by electric motors:
   The microcontroller cuts the electric power supply to the motor and its control system. (In this scenario, the machine not being controllable may stem from a failure in the main control system, or in an output device within it.)

### Sample System Block Diagram

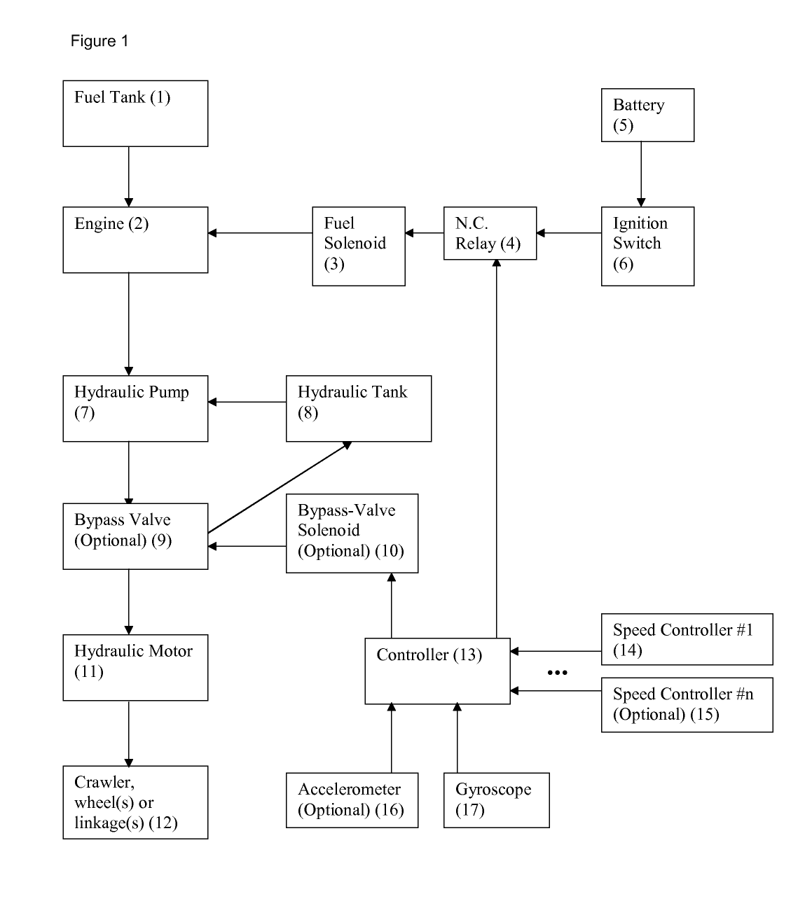

FIG. 1 is a block diagram illustrating, by way of example, pertinent drive and control components for one side of a machine that is propelled and steered by two crawlers—one on each side.

Pump, bypass valve and its solenoid (if they are installed), motor and crawler components for an opposite side are not shown.

In the machine described, the engine (2) draws fuel from the fuel tank (1); this action is controlled by the fuel solenoid (3), which must be energized to enable fuel to flow to the engine (2). A battery (5) through an ignition switch (6) typically provides power to the fuel solenoid (3). In accordance with an embodiment of the invention, a normally closed relay (4) is added in series, between the output of the ignition switch (6) and the fuel solenoid (3); this relay allows the controller (13) to shut off fuel flow to the engine (2), causing it to stop and disabling the machine.

In an alternative approach, which can be used in conjunction to that described above for redundancy, or in its stead, a bypass valve (9) is added to the existing machine. In the event that the hydraulic pump (7) still delivers oil to the hydraulic motor (11) when the operator wants the machine to stop, e.g. as evidenced by the speed controllers (14) and (15) being centered, the controller (13) can energize the bypass-valve solenoid (10). This diverts the flow of oil stemming from the hydraulic pump (7) back into the hydraulic tank (8), bypassing the hydraulic motor (11), thus starving it of oil, and causing the machine to stop.

The controller (13) decides whether or not to stop the machine based on the output from the gyroscope (17) and the speed controllers (14) and (15). For example, the output from the controller (13) will be activated if the speed controllers are centered, meaning that the machine should stop, but the machine is turning, i.e. it has a non-zero angular speed as measured by the gyroscope (17).

A typical machine, such as an asphalt paver, will have a single engine, but two hydraulic systems, each driving one side of the machine, and each including a pump and motor. In such a case, one bypass valve would be added to each side.

FIG. 2 illustrates an example controller (13) of FIG. 1 in greater detail. Note that one or more of the five optional signals—indicated by dashed lines—to external devices connected to the Output Drivers is to be present. Connections between external devices are not shown in this diagram. Within the controller (13), the signals from the gyroscope (17) and accelerometer (16), if one is installed, are modified by the amplifiers/signal conditioners/EMI filters (22), so that they are suitable to be read by the ND converter (20). The signals from the speed controllers (14) and (15) are similarly modified, except that they will typically require attenuation rather than amplification. The power filter, conditioner and voltage regulator (21) modifies the voltage obtained from the machine's charging system (battery and alternator) so it is suitable for an electronic module.

The microcontroller system (19) executes the program, reads the ND converter (20), makes a decision as to whether or not to activate its outputs, and controls the discrete-output drivers (18) accordingly. The latter will typically be solid-state high-side drivers, with an output current capacity of 1.5 A or higher.

### Program Description

The following describes an example of the program executed by the Controller (13), using pseudo-code. In it, reference is made to an alarm and shutdown indicators. These are optional devices, which may be used to inform the operator of the reason for the machine having stopped.

| | | |
|---|---|---|
| Start | | |
| De-activate outputs | /*enable machine motion | */ |
| Initialize | | |
| Read speed controllers | /*operator intended motion inputs | */ |
| Read machine angular speed | /*actual motion | */ |
| Read acceleration | /*actual motion | */ |
| Calculate desired angular speed | /*operator intended motion | */ |
| Calculate desired acceleration | /*operator intended motion | */ |

If (|desired angular speed − calculated angular speed| > threshold_1) or

| If (\|desired acceleration − calculated acceleration\| > threshold_2) then | |
|---|---|
| /* machine loss-of-control determined, take steps to disable and indicate: | */ |

Activate output(s) to stop machine movement
Activate alarm and shutdown indicator output(s)

End

### Program Variations

The program may be modified, for example, so as not to calculate the desired angular speed or acceleration, but rather whether they are positive, negative or zero. The decision to stop machine movements would be reached if the actual angular speed or acceleration differs in sign from the respective desired values or if they are supposed to be zero but are larger (in absolute value) than a predetermined threshold.

Machine loss-of-control may not be raised on an initial material difference of actual motion and operator intended motion determination. Loss-of-control may be further responsive to a persisted or repeated difference; for example, where the material difference persists over a predetermined period of time to allow the operator's commands to normally propagate through the machine's drive system and not raise false alarms.

Though not shown in the pseudo-code, delays (whether implemented in software and/or hardware) may be employed to match operator commands (i.e. reading speed controllers) with machine responses (i.e. reading actual motion) so as to allow the machine to react normally.

### Hardware Variations

The controller (13) output may be implemented, instead of using discrete power drivers, by way of a data bus interface or data link interface. In such a case, when the controller acts to disable the machine, it might do so by sending a command on the data bus or data link, e.g. to the engine controller to stop the engine. This hardware variation would impact the software as well, which would require implementation of the data bus or data link protocol.

Some pumps provide a pump output signal to indicate when and/or the degree to which the pump is open, for example, indicating when a swash plate for controlling pump flow is off-centre (i.e. open). An inference that the machine is moving when the pump is open may be made and that movement is likely uncontrolled. In an embodiment (not shown) including such a pump (7), the pump output signal may be coupled to an input of controller (13) to provide a signal to detect actual pump function. As well, controller 13 may be coupled to monitor a pump control signal for controlling the pump to detect intended pump function, determining when the pump control signal instructs the pump to close. Machine loss-of-control may be further responsive to the pump output signal and, optionally, the pump control signal. Loss of control may be indicated when the pump output signal indicates that the pump is open yet the operator's speed controller is centered or the pump control signal is instructing the pump to close. A suitable delay to allow the pump to respond to the pump control signal may be taken.

### A Second Implementation

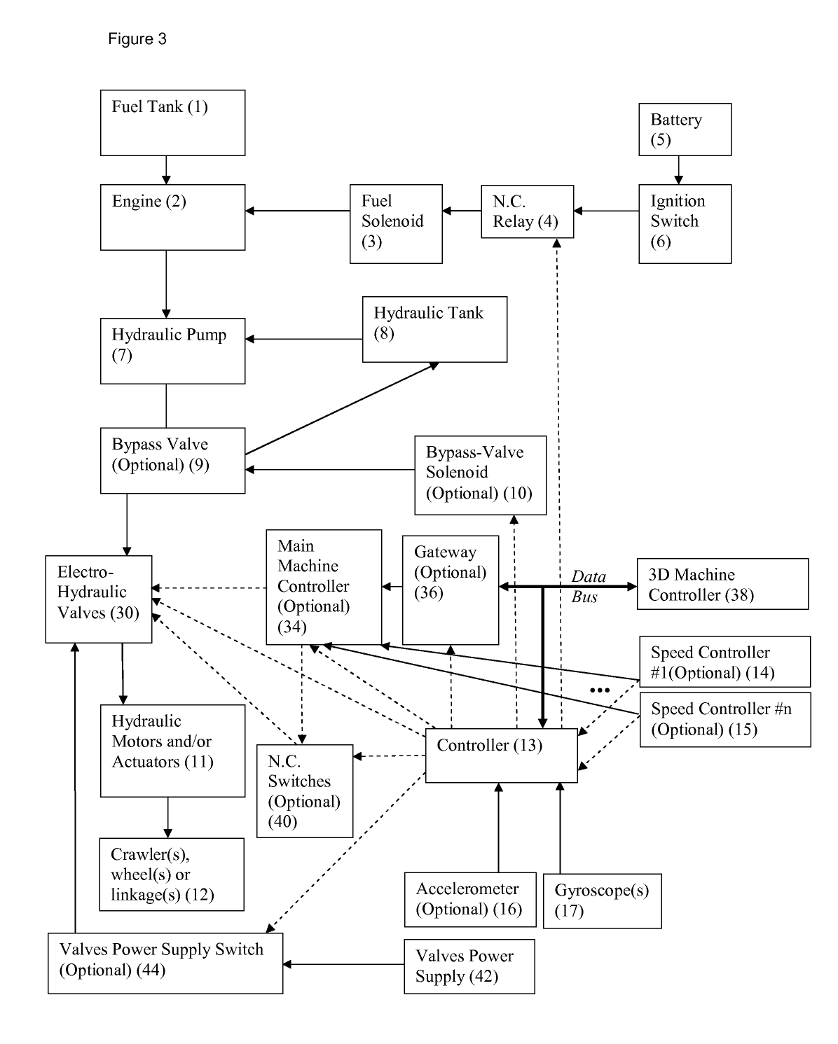

Referencing FIG. 3, in this second sample implementation/embodiment, a 3D control system provides operator intended motion. For example, the machine to be controlled may comprise a slip-form paver or curber controlled by a 3D Control System. Manual inputs (14) and (15) may also be present. The paver or curber may have three or four legs, each resting on a crawler; the legs may rotate in either direction for steering (by pointing the crawlers in various directions); the crawlers may be able to move forward or backward; and the length of each leg may vary to change the elevation of a corner of the machine.

Such machine may comprise a main machine controller (34), which receives commands from the operator, and/or from an automated system such as a 3D machine controller (38) either directly or translated by a gateway (36). Said commands indicate to the main machine controller (34) how the machine should behave, and the main machine controller (34) then generates outputs, which drive the electro-hydraulic valves (30), to cause the machine to behave accordingly.

Electro-hydraulic valves (30) control the flow of oil from the hydraulic pump (7) to the hydraulic motors and/or actuators (11), responding to the signals from valve drivers (not shown) that may be built into a main machine controller (34), a gateway (36) or a controller (13). These valves (30), which may be for example proportional valves or servo valves, may include built-in valve drivers and/or amplifiers (not shown), requiring electric power to operate; this electric power may be supplied from a valves power supply (42) or from the machine's charging system (not shown), either directly or through a valves power supply switch (44).

Electro-hydraulic valves (30) may comprise solenoids or servomotors or other electromechanical devices driven by signals output by valve drivers (not shown) that may be built into a main machine controller (34), a gateway (36) or a controller (13). Said signals may be connected either directly or through normally closed (N.C.) switches (40) controllable by controller (13). Absent these N.C. switches (40), the signals from the main machine controller (34) would be connected directly to the valves (30).

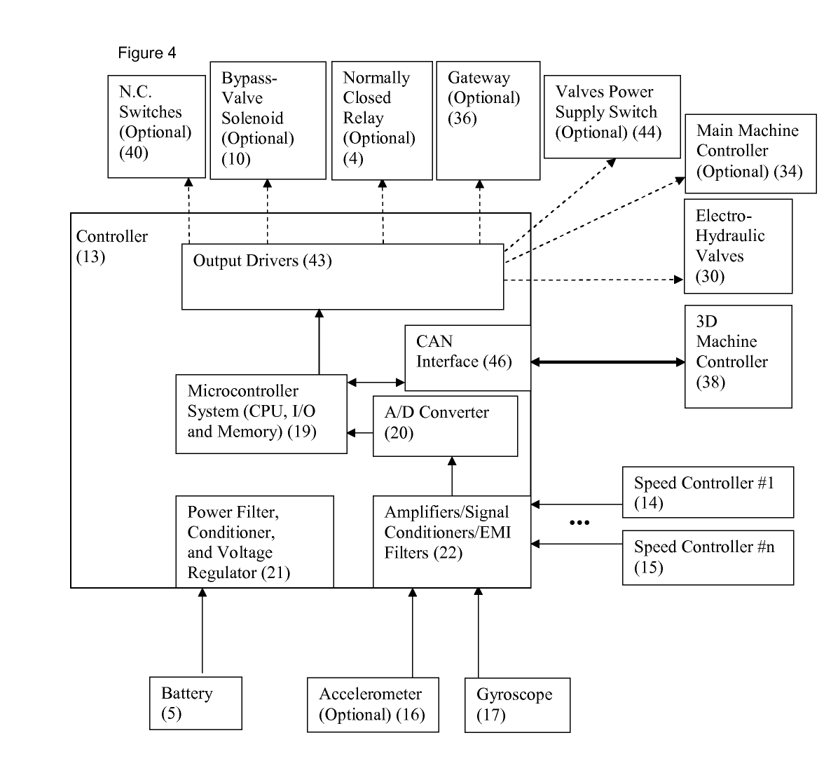

FIGS. 3 and 4 illustrate similar bock diagram configurations to the embodiment of FIGS. 1 and 2 respectively but configured for use with a 3D control system represented by 3D machine controller (38). In FIG. 3, dashed lines indicate redundant options: one or more of same may be used. In FIG. 4, one or more of the seven optional signals (outputs)—indicated by dashed lines—to external devices (4), (10), (30), (34), (36), (40) and (44) connected to the Output Drivers (18) may be present. Connections between these external devices (4), (10), (30), (34), (36), (40) and (44) and the equipment which they are controlling are not shown in this diagram.

Though illustrated with 3D machine controller (38), the embodiment of FIGS. 3 and 4 may be configured for use with human operator input such as via controllers (14) and (15). Hence intended motion may be derived from automatic or human operator controls.

FIG. 1 illustrates a bypass valve (9) and associated solenoid (10) to override operator intended motion. FIG. 3 shows an alternative configuration. There are hydraulic devices such as motors and pumps that have a built-in bypass (not shown), which can be driven directly (i.e. not requiring an external bypass valve) thus the need for a separate bypass valve (9) could be obviated. Though FIGS. 1 and 3 illustrate a hydraulic motor (11), hydraulic actuators or cylinders may be employed. Further, though the embodiments of FIGS. 1-4 relate to machines with a hydraulic system, the present teachings herein may be used, with suitable adaptation as may be necessary, in a machine that is driven by electric motors and actuators.

With further reference to FIG. 3, 3D machine controller (38) communicates with a gateway (36) via a CAN (Controller Area Network) (see interface (46) of FIG. 4) or other type of data bus, thus indicating to the gateway (36) what movements the machine should make. The gateway (36) then actuates the electro-hydraulic valves (30) either directly or by indicating to the main machine controller (34) what is the desired machine motion or what is the desired behavior of the electro-hydraulic valves (30).

Similarly to the description of FIG. 1 with respect to the crawler described, the vertical motion of each leg of the paver or curber may be detected by an accelerometer (16), to determine when each leg is moving undesirably; or one or more gyroscopes (17) may be used to detect when one or more legs are moving undesirably. Steering and propulsion problems may be detected by accelerometers (16) and/or one or more gyroscopes (17).

To stop undesired motion, one or more of the following measures may be undertaken:
As in the previous implementation, controller (13) may energize N.C. relay (4) and/or bypass-valve solenoid (10).
Valves (30) may be shut off by the controller (13) turning off the valves power supply switch (44), for example if the undesired motion is caused by a faulty main machine controller (34), gateway (36) or crawlers (12).
Controller (13) may prevent the valves (30) responding to commands, e.g. from the main machine controller (34) by disconnecting its outputs from said valves; it may do this, for example, opening the normally closed (N.C.) Switches (40): when these are energized, the circuits from the main machine controller (34) to the valves (30) would be interrupted. This approach would be useful, for example, if the main machine controller (34) was faulty and issuing inappropriate commands to the valves (30). This description applies also when the gateway (36) drives the valves (30) directly, for example when a main machine controller (34) is not controlling the valves (30).
Controller (13) may energize a Standby input (not shown) of the main machine controller (34) or of the gateway (36), causing it to output a null signal to the valves (30); this is useful if the problem is a software-related one—e.g., faulty zeroing or calibration, rather than it being caused by a hardware failure.

In response to an undesired motion being detected one or more degrees of freedom of the machine may be disabled; for example, an undesirable motion of one of the machine legs may or may not cause all legs to be disabled; also, an undesirable motion of a crawler may cause all crawlers to be disabled. This may be achieved by controller (13) selectively disabling one or more valves (30), or e.g. by it energizing a standby input (not shown) of a main machine controller (34).

In the previous Program Description of the first sample implementation, certain adaptations may be undertaken for a 3D control system embodiment. For example the pseudo-code:

| | | |
|---|---|---|
| Read speed controllers | /*operator intended motion inputs | */ |

May be replaced by:

| | |
|---|---|
| Determine the source of input commands | /* detect whether the input commands |

come from a CAN bus, an input device, or outputs from a main machine controller or a
gateway */

| | |
|---|---|
| Select input-commands source | /* if more than one valid source of input |

commands was detected, choose one following pre-determined criteria */

| | |
|---|---|
| Determine the Desired Speeds | /* read the intended-motion inputs from the |

input-commands source selected */

Thus, in addition to shutting the engine off, other means of control may be used. For example, shutting off electric power to the valves may be used. If the valves need a separate electric power input to operate (besides the control signals), e.g. to supply built-in electronics, that supply may be cut-off directly. Alternatively or in addition, shutting off power to an electric circuit on the machine that feeds—possibly through other devices—the valve drivers that give the valve the ability to operate (by supplying electric signals to them).

If the unintended motion problem is a software-related one, such as a wrong zeroing or calibration of the machine or its main controller, the embodiments herein can leave the valves operational, and instead of shutting them off, the controller (13) could add a correction to the control signal so that the machine moves as intended. This can be done e.g. by implementing a PID control loop within the systems disclosed herein: one implementation may consist of the gateway (36) receiving from the main machine controller (34) the value of the machine speeds(s), while the 3D machine controller (38) is issuing Standby or zero-motion commands, and based on this information adjusting the null voltage sent to valves (30) until machine motion ceases, whereby motion having ceased may be detected by means of one or more gyroscopes (17) and/or one or more accelerometers (16). This adjustment may be effected by ramping up or down the output voltage until motions ceases and then recording the output value that causes motion to cease, and thereafter using said value to generate a new null output signal. Another implementation can use the same method, except that, rather than ramping the output, a PID algorithm may be used with a zero input value to cause machine motion to cease and then using the resulting output voltage as the new null voltage. In another implementation, the main machine controller (34) receives the gateway outputs, adds to them a null offset value obtained as above, and outputs the result to the valves (30); in yet another implementation, the machine speed signals are output from the main machine controller (34) (or directly from one or more accelerometers (16) and/or one or more gyroscopes (17)) to the 3D machine controller, which uses this information as an input to its control algorithms.

It is further understood that modifications to the configuration of the second sample implementation are contemplated. Functions or features or some components can be performed by other components. For example controller (13) can be “built into” main machine controller (34), 3D machine controller (38) or gateway (36). The gyroscope(s) (17) and/or accelerometer(s) (16) could be connected to any one of main machine controller (34), 3D machine controller (38) or gateway (36) which could implement the function of controller (13) in software. One or more controllers may be included for these tasks.

In accordance with the embodiments and operations described herein, there is provided method and system aspects for detecting machine loss of control. Such may relate to the intended motion of a machine that is under human operator and/or automatic system control. Accordingly, there is further provided method and system aspects for acting in response to said machine loss of control. Acting in response may comprise correcting the actual motion, for example, stopping the machine such as by turning off the engine. However, more selective approaches may be taken, regulating (shutting off) electric power to certain valves, or to electric circuits that feed the valve drivers (directly or indirectly), which valve drivers provide signals to the valves. Acting may comprise applying a correction to one or more signals to align actual motion with intended motion. For example a correction to a control signal to correct for improper software or for improper calibration set-up/zeroing of the machine or its main controller may be provided. For correcting or stopping unintended motion, controller outputs can be coupled to, (e.g. via the external devices), at least one of:

stop a flow of fuel or electrical current to an engine of the machine;

stop a flow of electrical current to an electric motor of the machine;

stop a flow of hydraulic fluid to a hydraulic motor of the machine configured to drive the machine or a part of it;

stop a flow of hydraulic fluid to an actuator of the machine configured to drive the machine or a part of it;

stop the flow of electric current to a valve or to a valve driver for the valve;

energize a stand-by input of a machine controller to output a null signal to the valves or valve drivers;

energize a stand-by input of a gateway to output a null signal to the valves or valve drivers;

energize a stand-by input of a 2D or 3D machine controller to output a null signal to the valves or valve drivers; and

correct a control signal so that the machine or a part of it operates in accordance with said intended motion.

Those of skill in the art may effect alterations, modifications and variations to the particular embodiments without departing from the scope of the application. The subject matter described herein in the recited claims intends to cover and embrace all suitable changes in technology.

What is claimed is:

1. A method of machine loss of control detection comprising:
detecting intended motion of the machine or a part of it;
detecting actual motion of the machine or the part of it; and
determining machine loss of control in response to whether actual motion is materially different from intended motion;
wherein the step of detecting actual motion is responsive to angular motion signals from a gyroscopic angular sensor and, optionally, linear motion signals from at least one accelerometer.

2. The method of claim 1 further comprising the step of indicating said machine loss of control.

3. The method of claim 1 further comprising the step of correcting or stopping said actual motion in response to said step of determining machine loss of control.

4. The method according to claim 3 wherein the step of correcting or stopping comprises, at least one of:
stopping a flow of fuel or electrical current to an engine of the machine;
stopping a flow of electrical current to an electric motor of the machine;
stopping a flow of hydraulic fluid to a hydraulic motor of the machine configured to drive the machine or a part of it;
stopping a flow of hydraulic fluid to an actuator of the machine configured to drive the machine or a part of it;
stopping the flow of electric current to a valve or to a valve driver for the valve;
energizing a stand-by input of a machine controller to output a null signal to the valves or valve drivers;
energizing a stand-by input of a gateway to output a null signal to the valves or valve drivers;
energizing a stand-by input of a 2D or 3D machine controller to output a null signal to the valves or valve drivers; and
correcting a control signal so that the machine or a part of it operates in accordance with said intended motion.

5. The method according to claim 1 wherein the step of detecting intended motion comprises reading speed controller outputs that are responsive to human operator actions.

6. The method according to claim 1 wherein the machine comprises an automatic control system for providing intended motion and said step of detecting intended motion is responsive to said automatic control system.

7. The method according to claim 1, comprising:
detecting intended speed and at least one of actual angular speed and, optionally, actual acceleration;
for each one of actual angular speed and actual acceleration detected:
computing respectively intended angular speed and intended acceleration; and
determining machine loss of control in response to whether actual angular speed and actual acceleration are respectively materially different from intended angular speed and intended acceleration.

8. The method of claim 7 wherein the machine comprises at least one of a gyroscopic angular sensor for detecting the angular motion of the machine or a part of it;
and a pair of accelerometers for detecting acceleration of the machine or a part of it.

9. A system for determining machine loss of control comprising:
one or more controllers having one or more inputs for receiving indications of intended motion of the machine or a part of it and actual motion of the machine or a part of it and at least one output, said one or more controllers configured to detect said intended motion and actual motion and determine machine loss of control in response to whether actual motion is materially different from operator intended motion; and
wherein, for detecting the actual motion, at least one of said inputs receives angular motion signals from a gyroscopic angular sensor.

10. The system according to claim 9 wherein, for detecting the actual motion, at least one of said inputs receives linear motion signals from at least one accelerometer

11. The system according to claim 9 wherein the controller is configured to indicate said loss of control via said at least one output.

12. The system according to claim 9 wherein a one of the inputs receives speed controller outputs that are responsive to human operator actions.

13. The system according to claim 9 wherein the machine comprises an automatic control system for providing intended motion and one of said inputs is responsive to said automatic control system for detecting intended motion.

14. The system according to claim 9 comprising a gyroscopic angular motion sensor coupled to one of said inputs for indicating actual motion of the machine or a part of it.

15. The system according to claim 9 comprising at least one accelerometer sensor coupled to a respective at least one of said inputs for indicating actual motion of the machine or a part of it.

16. The system according to claim 9 wherein at least some of the at least one output are coupled to one or more devices configured to correct or stop said actual motion.

17. The system according to claim 16 wherein the one or more devices are configured to, at least one of:
stop a flow of fuel or electrical current to an engine of the machine;
stop a flow of hydraulic fluid to a hydraulic motor of the machine configured to drive the machine or a part of it;
stop a flow of hydraulic fluid to a hydraulic actuator of the machine configured to drive the machine or a part of it;
stop a flow of electric current to an electric motor of the machine configured to drive the machine or a part of it;
stop the flow of electric current to a valve or to a valve driver for the valve;
energize a stand-by input of a machine controller thereby to output a null signal to the valves or valve drivers;
energize a stand-by input of a gateway thereby to output a null signal to the valves or valve drivers;
energize a stand-by input of a 2D or 3D machine controller thereby to output a null signal to the valves or valve drivers; and
correct a control signal so that the machine or a part of it operates in accordance with said intended motion.

18. A computer program product comprising a computer readable medium storing instructions and data for configuring one or more controllers to execute operations to:
detect intended motion of the machine or a part of it;
detect actual motion of the machine or the part of it; and
determine machine loss of control in response to whether actual motion is materially different from intended motion;
wherein the step of detecting actual motion is responsive to angular motion signals from a gyroscopic angular sensor and, optionally, linear motion signals from at least one accelerometer.

19. The computer program product according to claim 18 wherein the operations further comprise indicating said machine loss of control.

20. The computer program product according to claim 18 wherein the operations further comprise correcting or stopping said actual motion in response to said step of determining machine loss of control.
